(19) United States
(12) Patent Application Publication
(10) Pub. No.: US 2023/0066329 A1
(43) Pub. Date: Mar. 2, 2023

(54) FILLED BAKERY PRODUCT

(71) Applicant: Brill, Inc., Tucker, GA (US)

(72) Inventors: David Michael THOMAS, Tucker, GA (US); Anthony REGINA, Tucker, GA (US); Raymond Lawrence ROSS, Tucker, GA (US)

(73) Assignee: Brill, Inc., Tucker, GA (US)

(21) Appl. No.: 17/408,194

(22) Filed: Aug. 20, 2021

(51) Int. Cl. A23L 19/00; A21D 13/31; A23L 29/219; A23L 29/30; A21D 15/02; A21D 13/19

(52) U.S. Cl. CPC A23L 19/03; A21D 13/31; A23L 29/219; A23L 29/30; A21D 15/02; A21D 13/19

(57) ABSTRACT

The present invention relates to a pourable fruit filling having a water activity in the range of 0.78 to 0.90, said fruit filling containing 10-40 wt. % of fruit pieces dispersed in 60-90 wt. % of a continuous phase, said continuous aqueous containing 18-48 wt. % water, 7-21 wt. % of one or more polyols selected from glycerine, propylene glycol, sorbitol, mannitol, xylitol and erythritol, and 30-60 wt. % of one or more sugars. The pourable fruit filling of the present invention may suitably be applied in the preparation of filled bakery products that exhibit surprising stability at room temperature. The invention further provides a filled bakery product comprising 10-60 wt. % of a pourable fruit filling according to the present invention and 40-90 wt. % of a casing of fully or partially cooked dough that encloses the pourable fruit filling.

### TECHNICAL FIELD OF THE INVENTION

The present invention relates to a pourable fruit filling comprising 10-40 wt. % of fruit pieces dispersed in 60-90 wt. % of a continuous water-containing phase, said continuous water-containing phase containing water, one or more polyols selected from glycerine, propylene glycol, sorbitol, mannitol, xylitol and erythritol, and one or more sugars.

The invention also relates to a filled bakery product comprising 10-60 wt. % of the aforementioned pourable fruit filling and 40-90 wt. % of a casing of fully or partially cooked dough that encloses the pourable fruit filling.

### BACKGROUND OF THE INVENTION

Fillings are key ingredients in many bakery products such as donuts, eclairs, pies and turnovers. Various types of fillings are used in commercial baking and food production, such as creams, chocolate ganache, fudges and fruit-based fillings. These fillings are typically applied to bakery products via depositing or injection.

For the best performance, fillings should be stable during storage, shelf life and baking. In case the filling contains a significant amount of water and is encased in a fully or partially cooked dough, storage stability of the filled bakery product may be impaired by migration of water from the filling towards the casing. As a result of this moisture migration during storage, the casing loses its crusty character and becomes soggy. This type of water migration may be reduced by decreasing the water content of the fillings and/or by including high concentration of hydrocolloids in the filling. However, for pourable fruit filling having a high content of fruit pieces, it is very difficult to significantly reduce the water content because the fruit pieces largely consist of water. Addition of high amount of hydrocolloids has the disadvantage that the filling becomes a gel or develops an unattractive sticky texture.

U.S. Pat. No. 4,623,542 describes a high moisture, shelf stable, breakfast pastry comprising a flavored pastry filling material having a viscosity of 20,000-60,000 cps, a starch content of 3.5-8 wt. %, a gum content of 0.15-0.4 wt. %, a pH from 2.8 to 7.5 and a total moisture content of 30-50%.

U.S. Pat. No. 6,299,916 describes a baked, shelf-stable, hand-held snack bar comprising 30-90 wt. % filling and 10-70 wt. % crust, wherein the composite water activity of the bar is from 065-0.85; wherein the crust is a baked crust prepared from a dough which, as formulated, has a water activity of 0.60 to 0.90; wherein the filling, as formulated, has a water activity of 0.60 to 0.90; and wherein the water activity of the dough, as formulated, and the filing, as formulated, differ by no more than 0.03 units.

US 2002/0039612 describes a baked and freezer stable filled waffle comprising: an outer casing material formed from a batter; said outer casing material surrounding a filling material having a positive water content of up to 40 wt. % and said water content in said filling material being less than in said outer casing material; and

said outer casing material having a water activity level of from 0.9 to 0.99 and said filling material having a water activity level of less than or equal to 0.95 with said water activity level of said filling material being less than said water activity level of said outer casing material.

US 2003/0091707 describes a fruit flavored filling having a low water activity comprising:
a) 0.1-30% by weight fruit;
b) 0.01-30% by weight of high melting point oil;
c) 0.01-50% by weight of low melting point oil, said melting point of the low melting point oil at least about 10[deg.] F. lower than the melting point of said high melting point oil;
d) 0.1-40% by weight humectant; and
e) an A_{w} of less than about 0.8.

### SUMMARY OF THE INVENTION

The present invention provides a pourable fruit filling having a water activity in the range of 0.78 to 0.90, said fruit filling containing 10-40 wt. % of fruit pieces dispersed in 60-90 wt. % of a continuous phase, said continuous aqueous containing 18-48 wt. % water, 7-21 wt. % of one or more polyols selected from glycerine, propylene glycol, sorbitol, mannitol, xylitol and erythritol, and 30-60 wt. % of one or more sugars.

The pourable fruit filling of the present invention may suitably be applied in the preparation of filled bakery products that exhibit surprising stability at room temperature. The pourable fruit filling of the present invention further offers the advantage that it is quite viscous and does not tend to leak from filled pastries.

The invention further provides a filled bakery product comprising 10-60 wt. % of a pourable fruit filling according to the present invention and 40-90 wt. % of a casing of fully or partially cooked dough that encloses the pourable fruit filling.

The filled bakery product of the present invention combines a crusty outer casing with a fluid fruity interior and exhibits surprising stability at room temperature, even after prolonged frozen storage. More particularly, the texture of the casing remains essentially unchanged when the filled bakery product is stored at room temperature for several weeks (under non-humid conditions).

The invention also provides a method of preparing a filled bakery product comprising 10-60 wt. % of a pourable fruit filling and 40-90 wt. % of a casing of fully or partially cooked dough, said method comprising:
preparing a pourable fruit filling by mixing 20-50 parts by weight of fruit pieces with 6-30 parts by weight of one or more polyols selected from glycerine, propylene glycol, sorbitol, mannitol, xylitol and erythritol; 15-65 parts by weight of a sugar source selected from sucrose, glucose, fructose, lactose, syrup and combinations thereof; and 0-25 parts by weight of water;
providing a dough layer;
depositing a portion of pourable fruit filling onto the dough layer;
wrapping the dough layer around the portion of filling to enclose the filling with the dough layer, thereby producing a filled dough portion; and
baking the filled dough portion to produce the filled bakery product;

wherein, after the baking, the pourable fruit filling has a water activity of 0.78 to 0.90 and the casing has a water activity of 0.70 to 0.85.

### DETAILED DESCRIPTION OF THE INVENTION

Accordingly, a first aspect of the present invention relates to a pourable fruit filling having a water activity in the range of 0.78 to 0.90 and comprising 10-40 wt. % of fruit pieces dispersed in 60-90 wt. % of a continuous phase, said continuous aqueous containing 18-48 wt. % water, 7-21 wt. % of one or more polyols selected from glycerine, propylene glycol, sorbitol, mannitol, xylitol and erythritol, and 30-60 wt. % of one or more sugars.

The term “pourable” as used herein means that the fruit filling has the characteristics of a fluid that can be poured from a container.

The term “fruit piece” as used herein refers to intact fruits of parts of fruits having a mesh size of at least 7 (2.80 mm).

The term “sugar” as used herein refers to carbohydrates selected from monosaccharides, disaccharides, trisaccharides and combinations thereof.

When reference is made to concentration of a component in a part of a filled bakery product (e.g. the fruit filling, the continuous phase of the fruit filling or the casing) that concentration refers to concentration in that particular part of the filled bakery product, unless indicated otherwise.

Whenever reference is made to water activity, what is meant is the water activity at a temperature of 20° C. and a pressure of 1 atmosphere.

The pourable fruit filling of the present bakery product preferably has a pH in the range of 2.0 to 5.5, more preferably a pH in the range of 2.5 to 4.5, most preferably a pH in the range of 3.0 to 3.5.

The fruit filling preferably has a water activity in the range of 0.80 to 0.88, more preferably in the range of 0.82 to 0.86.

The continuous phase of the fruit filling preferably is a viscous liquid as a viscous liquid can be deposited in portions on a dough layer without immediately running off, thus allowing time for wrapping the dough layer around the filling. Preferably, the continuous phase has a viscosity of at least 50 Pa·s (100,000 cps) at 5 rpm and 20° C. More preferably, the continuous phase has a viscosity of 100 to 1,000 Pa·s at 5 rpm and 20° C. Most preferably, the continuous phase has a viscosity of 200 to 800 Pa·s at 5 rpm and 20° C. Viscosities can suitably be measured using a Brookfield DV-E Viscometer with T-bar Spindle E at 5 RPM (using the helipath function).

Preferably, at least 80 wt. % of the fruit pieces in the fruit filling has a mesh size of at least 6 (3.35 mm). Most preferably, at least 80 wt. % of the fruit pieces in the fruit filling have a mesh size of at least 5 (4.00 mm) and of not more than 1 inch (25.4 mm).

The fruit pieces in the fruit filling may originate from a large variety of fruits. Examples of fruits that may be used include cranberry, goji berry, grape, cherry, strawberry, raspberry, blackberry, blackcurrant, boysenberry, elderberry, redcurrant, damson, plum, gooseberry, mulberry, chokeberry, amla berry, rhubarb, date, apple, pear, orange, lemon, lime, grapefruit, tangerine, satsuma, banana, mango, kiwi fruit, kumquat, lychee, papaya, melon, water melon, apricot, peach, nectarine, coconut, fig, pineapple, pomegranate and combinations thereof.

The fruit filling of the present invention may be prepared using fruit pieces that have not undergone any processing or modification other than cutting. Alternatively, however, the fruit filling may be prepared using e.g. sugar-infused fruit piece, that may have been pre-dried. The fruit pieces in the fruit filling typically have a water content in the range of 35 to 70 wt. %. More preferably, the water content of the fruit pieces is in the range of 40 to 65 wt. %, most preferably in the range of 42 to 60 wt. %.

The water content of the continuous phase of the fruit filling preferably is in the range of 20-46 wt. %, more preferably in the range of 25-44 wt. %, most preferably in the range of 30-42 wt. %.

The one or more polyols in the continuous phase of the fruit filling are preferably selected from glycerine, propylene glycol, xylitol and sorbitol. More preferably the one or more polyols are selected from glycerine and propylene glycol. Most preferably, the one or more polyols is glycerine.

The continuous phase of the fruit filling preferably contains 8-20 wt. %, more preferably 9-18 wt. % and most preferably 10-17 wt. % of the one or more polyols.

In accordance with another preferred embodiment, water and the one or more polyols are present in the continuous phase in a weight ratio that lies in the range of 1:2 to 5:1, more preferably phase in a weight ratio that lies in the range of 1:1 to 4:1 and most preferably phase in a weight ratio that lies in the range of 2:1 to 3.5:1.

The combination of water, the one or more polyols and the one or more sugars preferably constitutes at least 80 wt. %, more preferably at least 90 wt. % and most preferably at least 92 wt. % of the continuous phase.

The one or more sugars that are present in the continuous phase of the fruit filling are preferably selected from sucrose, fructose, glucose, lactose, maltose, maltotriose and combinations thereof. More preferably, the one or more sugars are selected from sucrose, fructose, glucose and combinations thereof.

The continuous phase of the fruit filling preferably contains 32-55 wt. %, more preferably 34-50 wt. % and most preferably 36-48 wt. % of the one or more sugars.

The continuous aqueous phase of the filling advantageously contains 2-10 wt. % of modified starch, more preferably 3-9 wt. % of modified starch, most preferably 5-8 wt. % of modified starch.

According to a particularly preferred embodiment, the modified starch is a hydropropyl di-starch phosphate.

In a further preferred embodiment, the continuous aqueous phase of the fruit filling contains 0.1-2 wt. %, more preferably 0.15-1 wt. % and most preferably 0.2-0.6 wt. % of one or more gums selected from pectin, guar, locust bean, tara, gellan, alginate, tragacanth, karaya, Ghatti, agar, gelatin, arabic, acacia, carrageenan, xanthan, cellulose, carboxymethylcellulose, hydroxypropylmethocellulose.

The continuous phase of the fruit filling preferably contains an acidulant selected from citric acid, malic acid, sorbic acid, gluconic acid, glucono delta-lactone, hydrogen chloride and combinations thereof.

The acidulant is preferably contained in the continuous phase in a concentration of 0.05-1% by weight of water, more preferably 0.1-0.8% by weight of water, most preferably 0.15-0.6% by weight of water.

Another aspect of the invention relates to a filled bakery product comprising 10-60 wt. % of a pourable fruit filling according to the present invention and 40-90 wt. % of a casing of fully or partially cooked dough that encloses the pourable fruit filling

The casing that encloses the pourable fruit filling of the filled bakery product may be a fully or partially cooked dough. If the casing is partially cooked (e.g. par-baked), in order to prepare the product for eating, the end user has to heat the product to fully cook the dough of the casing. The heating may, for instance, be done in an oven. Preferably, the casing that encloses the pourable fruit filling is a casing of fully cooked dough.

The casing of fully or partially cooked dough preferably has a water activity in the range of 0.70 to 0.88, more preferably in the range of 0.72 to 0.85, most preferably in the range of 0.73 to 0.81.

According to a particularly preferred embodiment, the filled bakery product of the present invention is a filled puff pastry product. Accordingly, the casing of fully or partially cooked dough preferably is a casing of fully or partially cooked laminated dough.

The casing of fully or partially cooked laminated dough preferably comprises 8-80, more preferably 15-40 discrete fat layers per mm, wherein the layer density is determined in the direction that is perpendicular to the orientation of these layers.

The filled bakery product of the present invention typically has a weight in the range of 50 to 250 grams, more preferably in the range of 60 to 180 grams and most preferably in the range of 75 to 150 grams.

The water activity of the fruit filling and the water activity of the casing preferably differ by no more than 0.15 unit, more preferably by no more than 0.10 units, most preferably by no more than 0.05 units.

The filled bakery product typically comprises 25-50 wt. % of the pourable fruit filling and 50-80 wt. % of the casing of fully or partially cooked dough. Even more preferably, the filled bakery product comprises 28-40 wt. % of the pourable fruit filling and 55-70 wt. % of the casing of fully or partially cooked dough.

The combination of the pourable fruit filling and the casing of fully or partially cooked dough typically constitutes at least 60 wt. %, more preferably at least 70 wt. % and most preferably at least 80 wt. % of the filled bakery product.

The casing of fully or partially cooked dough that encloses the pourable fruit filling may completely enclose the filling or it may contain slits or openings through which the filling is visible. Preferably, the casing of fully or partially cooked dough completely encloses the pourable fruit filling.

Besides the pourable fruit filling and the casing of fully or partially cooked dough, the filled bakery product may comprise one or more additional components that are applied onto the casing, such as icing, glaze, frosting and/or decoration.

The casing of the fully or partially cooked dough preferably has an average thickness of 2-30 mm, more preferably of 2.5-20 mm and most preferably of 3-15 mm.

The specific volume of the casing of fully or partially cooked dough typically is in the range of 1.05 to 1.4 ml/g, more preferably in the range of 1.1 to 1.3 ml/g.

The casing of fully or partially cooked dough may be unleavened or it may have been leavened by the action of yeast or a leaving agent. Preferably, the casing of fully or partially cooked dough is non-leavened.

The casing of fully or partially cooked dough may have been cooked by different heating techniques, such as baking and/or frying. Preferably, the casing of fully or partially cooked dough is a casing of fully baked dough.

Yet another advantage of the filled bakery product of the present invention lies in its freeze-thaw stability. Accordingly, in a further preferred embodiment, the filled bakery product is a frozen product.

Another aspect of the invention relates to a method of preparing a filled bakery product comprising 10-60 wt. % of a pourable fruit filling and 40-90 wt. % of a casing of fully or partially cooked dough, said method comprising:
preparing a pourable fruit filling by mixing 20-50 parts by weight of fruit pieces with 6-30 parts by weight of one or more polyols selected from glycerine, propylene glycol, sorbitol, mannitol, xylitol and erythritol; 15-65 parts by weight of a sugar source selected from sucrose, glucose, fructose, lactose, syrup and combinations thereof; and 0-25 parts by weight of water;
providing a dough layer;
depositing a portion of pourable fruit filling onto the dough layer;
wrapping the dough layer around the portion of filling to enclose the filling with the dough layer, thereby producing a filled dough portion; and
baking the filled dough portion to produce the filled bakery product;

wherein, after the baking, the pourable fruit filling has a water activity of 0.80 to 0.86 and the casing has a water activity of 0.78 to 0.90 and wherein the water activity of the filling and the water activity of the casing differ by no more than 0.3 units.

The mixing of fruit pieces, the one or more polyols, the sugar source and water does not need to be done in a specific order.

In a preferred embodiment of the present method, the method produces a filled bakery product as described herein before.

Preferably, the pourable fruit filling is prepared by mixing 25-45 parts by weight of fruit pieces with 8-20 parts by weight of the one or more polyols; 30-55 parts by weight of the sugar source; and 0-20 parts by weight of water. More preferably, the pourable fruit filling is prepared by mixing 28-40 parts by weight of fruit pieces with 9-16 parts by weight of the one or more polyols; 32-50 parts by weight of the sugar source; and 0-15 parts by weight of water.

Preferably, the pourable filling that is prepared by mixing fruit pieces, one or more polyols, sugar source and optionally water, has a total water content of 25-50 wt. %, more preferably of 30-45 wt. % and most preferably of 32-42 wt. %.

The pourable filling that is prepared by mixing fruit pieces, one or more polyols, sugar source and optionally water, preferably contains 20-50 wt. % of fruit pieces dispersed in 50-80 wt. % of a continuous phase, said continuous aqueous containing 12-30 wt. % water, 12-30 wt. % of one or more polyols selected from glycerine, propylene glycol, sorbitol, and mannitol, xylitol and erythritol, and 35-65 wt. % of one or more sugars.

The one or more polyols employed in the present method are preferably selected from glycerine, propylene glycol, xylitol and sorbitol. More preferably the one or more polyols are selected from glycerine and propylene glycol. Most preferably, the one or more polyols is glycerine.

The syrup that is employed in the present method is preferably selected from glucose syrup, corn syrup (including high fructose corn syrup), maple syrup, cane syrup, golden syrup and combinations thereof.

The dough layer provided in the present method preferably is a layer of laminated dough.

In accordance with a preferred embodiment the preparation method additionally comprises freezing the baked filled dough portion.

The invention is further illustrated by the following non-limiting examples.

### EXAMPLES

### Example 1

A batch of 4,000 lbs fruit filling was prepared on the basis of the recipe shown in Table 1.

TABLE 1

| | Wt. % |
|---|---|
| Diced apples (90% moisture) | 33.6 |
| Water | 5.9 |
| Glycerine | 11.9 |
| Sucrose | 12.4 |
| Corn syrup 63/43 (18% moisture) | 17.3 |
| High fructose corn syrup (29% moisture) | 13.2 |
| Hydropropyl di-starch phosphate | 5.0 |
| Locust bean gum | 0.3 |
| Sorbic acid | 0.1 |
| Malic acid | 0.1 |
| Flavoring | 0.3 |

Eighteen pieces of raw apple had a combined weight of 11.63 grams.

The fruit filling was prepared as follows:

The locust bean gum and 10 wt. % of the sucrose were mixed, after which the HFCS, glycerine, starch, acids and flavouring were admixed. Next, the water was admixed, followed by addition of the diced apples. The resulting mixture was heated in 20-30 minutes to 190° F. (88° C.) and the corn syrup and remaining sucrose was added. After 5 minutes, the fruit filling so obtained was cooled to 170° F. (77° C.) and packed into drums.

Fruit pieces and continuous phase were taken from the drums 1 week after production. The combined weight of 18 fruit pieces had decreased to 5.65 grams, showing that moisture from the raw fruit pieces had been released during cooking. The cooked fruit pieces had a moisture content of 48.0 wt. %. The continuous phase of the cooked filling had a moisture content of 39.7 wt. %.

A dough was prepared on the basis of the recipe that is shown in Table 2.

TABLE 2

| | Wt. % |
|---|---|
| Bread flour | 31.4 |
| High gluten flour | 31.4 |
| Salt | 0.6 |
| Dextrose | 1.3 |
| Fat | 1.4 |
| Cold water | 20.7 |
| Ice | 13.2 |

The dough so obtained was laminated using approximately 410 grams of shortening per kg of dough to produce a laminated dough layer having a thickness of 3 mm and containing 64 discrete fat layers.

The dough layer was cut into squares of 5.0×5.0 inches (12.7×12.7 cm). About 31 grams of the fruit filling were deposited on each dough square after which the dough was wrapped around filing and sealed by crimping together the dough edges. The filled dough pieces were sprayed with an aqueous coating liquid followed by the application of sanding sugar. The total weight of the coated filled dough pieces was approximately 88 grams.

Next, the filled dough pieces were baked in a preheated oven at 375° F. (191° C. for 32 minutes to produce a fruit filled puff pastry. The baked products were cooled with ambient air until about 80° F. (27° C.). The products were packaged in plastic clamshell packaging suitable for retail display and then cased in corrugated boxes, stacked on pallets and stored in −10° F. (−23° C.) freezer.

Before freezing, some pieces of fruit filled puff pastry were retained for analysis. The fruit filling and the casing were separated and the water activity of each was measured at 20° C. and atmospheric pressure. The results are shown in Table 3.

TABLE 3

| | Water activity |
|---|---|
| Fruit filling | 0.84 |
| Casing | 0.78 |

The remaining fruit filled puff pastries were packaged in a clear non-hermetically sealed clam-shell style package and frozen.

After a few weeks of frozen storage, the frozen pastries were removed from the freezer and kept under ambient conditions. After 10 days of ambient storage, the pastries were still of very good quality. Prolonged storage resulted in staling and drying out of the casing, which shows that water migration from the filling towards the casing was effectively prevented.

### Example 2

Example 1 was repeated except that the diced apples were replaced by individually quick frozen (IQF) cherries. The cherries contained 8.2 wt. % sugars and 88.7 wt. % water.

### Example 3

Example 1 was repeated except that the diced apples were replaced by individually quick frozen (IQF) pieces of peach. The peach pieces contained 8.4 wt. % sugars and 88.9 wt. % water.

### Example 4

Example 1 was repeated, except that this time additionally a fruit filling was prepared in which the glycerine had been completely replaced by sucrose.

It was found that the fruit filling that did not contain glycerine had a much lower viscosity and had a tendency to leak out of the filled pastry. Furthermore, the shelf-life of the filled pastry product comprising the glycerine-containing filling was clearly superior to that of the filled pastry product comprising the filling in which the glycerine had been replaced by sucrose.

1. A pourable fruit filling having a water activity in the range of 0.78 to 0.90, said fruit filling comprising 10-40 wt. % of fruit pieces dispersed in 60-90 wt. % of a continuous phase, said continuous aqueous containing 18-48 wt. % water, 7-21 wt. % of one or more polyols selected from glycerine, propylene glycol, sorbitol, mannitol, xylitol and erythritol, and 30-60 wt. % of one or more sugars.

2. The pourable filling according to claim 1, wherein the filling has a pH in the range of 2.0 to 5.5.

3. The pourable filling according to claim 1, wherein the continuous phase is a viscous liquid.

4. The pourable filling according to claim 1, wherein the continuous phase has a viscosity of at least 50 Pa·s at 5 rpm and 20° C.

5. The pourable filling according to claim 1, wherein the one or more polyols are selected from glycerine and propylene glycol.

6. The pourable filling according to claim 1, wherein water and the one or more polyols are present in the continuous phase in a weight ratio that lies in the range of 1:2 to 5:1.

7. The pourable filling according to claim 1, wherein the combination of water, the one or more polyols and the one or more sugars constitutes at least 80 wt. % of the continuous phase.

8. The pourable filling according to claim 1, wherein the one or more sugars are selected from sucrose, fructose, glucose, lactose, maltose, maltotriose and combinations thereof.

9. The pourable filling according to claim 1, wherein the continuous aqueous phase of the filling contains 2-10 wt. % of modified starch.

10. The pourable filling according to claim 9, wherein the modified starch is hydropropyl di-starch phosphate.

11. The pourable filling according to claim 1, wherein the continuous aqueous phase of the filling contains 0.1-2 wt. % of one or more gums selected from pectin, guar, locust bean, tara, gellan, alginate, tragacanth, karaya, Ghatti, agar, gelatin, arabic, acacia, carrageenan, xanthan, cellulose, carboxymethylcellulose, hydroxypropylmethocellulose and combinations thereof.

12. The filled bakery product comprising 10-60 wt. % of a pourable fruit filling according to claim 1 and 40-90 wt. % of a casing of fully or partially cooked dough that encloses the pourable fruit filling.

13. The filled bakery product according to claim 12, wherein the casing has a water activity of 0.78-0.86.

14. The filled bakery product according to claim 12, wherein the water activity of the filling and the water activity of the casing differ by no more than 0.15 units.

15. The filled bakery product according to claim 12, wherein the casing of fully or partially cooked dough is a casing of fully or partially cooked laminated dough.

16. The filled bakery product according to claim 15, wherein the casing comprises 15-40 discrete fat layers per mm.

17. The filled bakery product according to claim 12, wherein the casing has an average thickness of 2-30 mm.

18. The filled bakery product according to claim 12, wherein the casing has a specific volume of 1.05-4 ml/g.

19. The filled bakery product according to claim 12, wherein the casing of fully or partially cooked dough is non-leavened.

20. The filled bakery product according to claim 12, wherein the casing is a casing of fully baked dough.

21. The filled bakery product according to claim 12, wherein the combination of filling and casing constitutes at least 80 wt. % of the filled bakery product.

22. The filled bakery product according to claim 12, wherein the casing of fully or partially cooked dough completely encloses the pourable fruit filling.

23. The filled bakery product according to claim 12, wherein the product is frozen.

24. A method of preparing a filled bakery product comprising 10-60 wt. % of a pourable fruit filling and 40-90 wt. % of a casing of fully or partially cooked dough, said method comprising:
preparing a pourable fruit filling by mixing 20-50 parts by weight of fruit pieces with 6-30 parts by weight of one or more polyols selected from glycerine, propylene glycol, sorbitol, mannitol, xylitol and erythritol; 15-65 parts by weight of a sugar source selected from sucrose, glucose, fructose, lactose, syrup and combinations thereof; and 0-25 parts by weight of water;
providing a dough layer;
depositing a portion of pourable fruit filling onto the dough layer;
wrapping the dough layer around the portion of filling to enclose the filling with the dough layer, thereby producing a filled dough portion; and
baking the filled dough portion to produce the filled bakery product;
wherein, after the baking, the pourable fruit filling has a water activity of 0.78 to 0.90 and the casing has a water activity of 0.70-0.85.

25. The method according to claim 24, wherein the pourable filling that is prepared by mixing fruit pieces, one or more polyols, sugar source and optionally water, has a total water content of 25-50 wt. %.

26. The method according to claim 24, wherein the pourable filling that is prepared by mixing fruit pieces, one or more polyols, sugar source and optionally water, contains 20-50 wt. % of fruit pieces dispersed in 50-80 wt. % of a continuous phase, said continuous aqueous containing 12-30 wt. % water, 12-30 wt. % of one or more polyols selected from glycerine, propylene glycol, sorbitol, and mannitol, xylitol and erythritol, and 35-65 wt. % of one or more sugars.

27. The method according to claim 24, wherein the method produces a filled bakery product.

28. The method according to claim 24, wherein the method additionally comprises freezing the baked filled dough portion.
